(19) United States
(12) Patent Application Publication
(10) Pub. No.: US 2023/0177593 A1
(43) Pub. Date: Jun. 8, 2023

(54) All in one rentals and services app

(71) Applicant: Omid Afkhami, Plano, TX (US)

(72) Inventor: Omid Afkhami, Plano, TX (US)

(21) Appl. No.: 17/544,206

(22) Filed: Dec. 7, 2021

(51) Int. Cl. G06Q 30/06; G06Q 20/36; H04L 67/52; G06F 3/0482

(52) U.S. Cl. CPC G06Q 30/0643; G06Q 30/0633; G06Q 20/36; H04L 67/18; G06F 3/0482

(57) ABSTRACT

A method and apparatus are disclosed detailing a smartphone software application providing an online venue for transacting commerce via internet. A software program and a database are embedded on a computer server connecting to a plurality of smartphone software applications via internet. The software program provides a simulated virtual storefront for providers to offer services, goods for rent and sale and property for rent. The software program further enables clients in need of services, goods and property to negotiate a commercial transaction with the providers. A user of the software application can be either a provider, and/or a client. If there is no offer satisfying the client's need, the client can list the need on a demand list, making it available to all users enticing providers to offer what the client needs.

### FIELD OF DISCLOSURE

The present disclosure relates to a smartphone application providing a venue for transacting commerce using internet. More specifically this disclosure relates to a method and apparatus enabling internet-based commerce where a user can both offer or need goods, property and services.

### BRIEF DESCRIPTION OF THE DRAWINGS

The drawings, when considered in connection with the following description, are presented for the purpose of facilitating an understanding of the subject matter sought to be protected.

FIG. 1 shows an example of a landing page of the software application;

FIG. 2 shows an example of a provider offering goods for rent and sale and property for rent page;

FIG. 3 shows an example of a provider offering a service page;

FIG. 4 shows an example of a client needing goods for rent or buy and property for rent page;

FIG. 5 shows an example of a client needing a service page;

FIG. 6A shows an example of a first subsection of a schematic functional interrelation flowchart diagram;

FIG. 6B shows an example of a second subsection of a schematic functional interrelation flowchart diagram;

FIG. 6C shows an example of a third subsection of a schematic functional interrelation flowchart diagram;

FIG. 6D shows an example of a fourth subsection of a schematic functional interrelation flowchart diagram; and

FIG. 6E shows an example of a fifth subsection of a schematic functional interrelation flowchart diagram.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed.

Briefly described, a method and apparatus are disclosed detailing a smartphone software application providing an online venue for transacting commerce via internet. A software program and a database are embedded on a computer server connecting to a plurality of smartphone software applications via internet. The software application can also be installed on any other computing platform including a desk top, a lap top or any portable computing platform. Both the software program and the software application are embedded on a readable medium, which is a non-transient memory device on the computer server or the smartphone The software program provides a simulated virtual storefront for providers to offer services, goods for rent and sale and property for rent. The software program further enables clients in need of services, goods and property to negotiate a commercial transaction with the providers. A user of the software application on the smartphone can designate herself as a provider by offering services, goods or property, and alternatively a user can designate herself as a client by stating a need and searching for offered services, goods and property. In situations where there is no offer satisfying a client's need, the client can list what she is looking for on a demand list and make the demand list available to all users enticing providers to offer what the client is searching for as her need.

The user initially registers with the software program and provides personal and financial information. Once the user is registered, she can designate herself as a provider and offer services, goods or property on the virtual storefront and specify characteristics of the offer including type, duration, delivery and collection time, location, price, and any client eligibility requirements associated with the offer. The provider can also provide an option for the client to try goods as rental before the client makes an offer to buy the goods under a Try Before Buy (TBB) feature in the software application. The provider, at the time of the offer, can identify another user as someone who had influenced the provider in her offering and from that point on both the provider and the identified user will get a percentage of the fee that goes to the software application for each transaction on the offer.

The services that the provider can offer includes voice and music lessons, math, science and art tutoring, fitness training, professional services comprising cosmetic, medical, accounting, engineering, financial consulting and legal advice, baby-sitting, house sitting, animal care, and dog walking.

The goods that the provider can offer for rent or sale includes tools, vehicles, household items, furniture, clothing, books via download or hardcopy, music via download or via a storage device, musical instrument, sound systems, professional tools including carpentry tools, electrical tools, construction tools, engineering tools, medical instruments, and gardening tools.

The property that a provider can offer includes residential and commercial property for rent.

The temporary housing that a provider can offer for rent or lease includes residential housing, apartments, individual rooms in a residence, vacation housing, and storage facilities.

Alternatively, the user can designate herself as a client searching for what she needs and after finding a suitable offer to either accept the characteristics posted by the provider or make a counteroffer different from what the provider is requesting and negotiate a commercial transaction to get the desired service, goods or property.

In various embodiments of present disclosure, a system for transacting commerce using internet is disclosed. The system includes a software application embedded on a readable medium on a smartphone; where the software application provides an internet-based commerce venue for offering and bidding on services, goods including vehicles for rent and sales, property for rent and temporary housing for rent.

A user on the software application can select a designation as a provider by selecting to make an offer; or the user can alternatively select a designation as a client by selecting to identify a need.

The user next selects an option for a service or an option to rent goods or property for the offer or the need; and the provider next identifies the services, the goods or the property for the offer and associated characteristics including timing, delivery, cost and any associated restrictions.

If there is no present offer satisfying the identified need the client can list the need under a demand list; and make the demand list available to all users to entice the providers to provide offers for items in the demand list.

The user during registration with the software application establishes an account and provides identifying and financial information. The user further establishes a wallet to make payments and receive funds for transactions initiated through the software application and for transferring funds in and out of the wallet.

The identifying information includes a user name, a nickname, an address, a government issued identification numbers, and a birth date, and the financial information includes information on financial accounts including a bank account information, a credit card information, and other financial institution information. The financial information further includes an authorization for deposit into and withdraw from the financial accounts. The software application can provide a number of different financial transaction reports for accounting and tax purposes.

The software application can provide information in different currencies, languages and measurement units according to user preference or a geographical location the information is entered or accessed. The software application also alerts users as to different time zones when requesting or offering the services.

The user as the provider identifies characteristics of the service transaction as to service type, location, duration, timing and price, and for characteristics of the goods for sale or rent or the property for rent transaction provider identifies the type of the goods or property, required eligibilities of the client bidding for the goods or property, delivery and collection location, duration and price for rent or sale of the goods or rent of the property. The eligibility requirement includes consideration of the client's history of transactions and quality rating, dynamic real time user identified criteria, pre-established criteria including client's training or certification in use of the goods, client minimum age requirement, or a combination of these requirements. As for “Renting Vehicle Eligibility” the client's eligibility requirement may include possession of a driver license, having certification for operating specific kinds of vehicles such as farm vehicles or construction and warehouse vehicles, minimum age requirement, good history of operating similar vehicles, having insurance covering operation of the vehicle, or a combination of some or all of these criteria. The dynamic real time user identified criteria as an eligibility criterion is defined as when the provider proposes a new eligibility requirement criterion and the Muferral software application provides a history of that criterion as it relates to a client or starts tracking that criterion to build a track history for clients as a new eligibility measure. Examples of dynamic real time user identified criteria include on time return of a rented equipment, returning a rented car with a full tank of gas when the car was rented with a full tank of gas, or condition of the returned goods. A client user can also propose a dynamic real time user identified criteria associated with the goods, property or services a provider offers. Such criteria may be attributes related to the offer for other clients to review before bidding on a specific offer. Examples of client user proposed dynamic real time user identified criteria to be tracked include quality, quantity or timeliness of a service, quality of a property such as proximity to a desired amenity or public transportation or quality of the property, quality of goods may be age of the item, how well it operates, its appearance, and examples for a person who is offering her services for acting in a commercial may be the appearance of the person or her ability to memorize quotes in the advertisement plot. These identified criteria will be voted on by different clients and their rating votes will be tracked and provided for other user clients when the goods, service or properties are reviewed for bidding.

The provider may identify another user influential in the transaction offer at the time that the provider makes the offer. This results in both the provider and the other user to receive a percentage of transaction fee that is payable to the software application (the service fee) for each transaction involving the offer.

The client user when bidding for services, goods to rent or buy or property to rent can see the available offers identified on a map. To limit the area where offers are identified on the map, one method is to identify a center and a radius distance identifying a circular area around the center to establish a search area. Alternatively, the client user has the option to limit a search area for available offers on the map by drawing a boundary around an area of interest on the map displayed on the smartphone screen. One method to establish a drawn boundary is to have the map fixed in place on the pressure sensitive screen of the smartphone, by the user client picking an option for drawing a boundary on the map, and then have the user client using her fingertip or a stylus to draw one or more enclosed boundaries encompassing the search areas of the interest for the offers on the map. When working on a computing device that does not have a pressure sensitive screen the user client can draw the boundary using a pointing device such as a computer mouse on the map which is fixed on the screen, where the map does not move on the screen by moving the pointing device on the map.

The client has the option to click on an “Online Only” icon indicating he is looking for a service that is provided online for situations where the client is open to receive services such as guitar lessons online. After selecting a suitable offer, client can accept the provider identified characteristics of the goods or property or makes a bidding offer that is different from the provider's proposed price, time and duration availability.

The provider can provide an option for the client to try the goods as rental before buying the goods.

In various embodiments of present disclosure, a method is disclosed for transacting commerce using internet. The method further includes a user using a software application embedded on a readable medium on a smartphone, providing an internet-based commerce venue for offering and bidding on services, goods including vehicles for rent and sales, property for rent and temporary housing for rent.

The user can be selecting a designation as a provider by selecting to make an offer on the software application; or alternatively, the user can be selecting the designation as a client by selecting to identify a need. The data entry or identifying selections can be done by different methods including using manual entry by typing or touching the screen or via voice commands.

The user next will be selecting an option for a service or an option to lease goods or property for the offer or the need; and the provider will next be identifying the services, the goods or the property for offer and associated characteristics including timing, delivery, cost and any associated restrictions.

In various embodiments of present disclosure, a software program product is disclosed providing a virtual storefront for transacting commerce via internet. The software program product includes a software program including a database embedded on a readable medium on a server computer, communicating via internet with a plurality of software applications embedded on a plurality of smartphones.

The software program registers users of the software application as a provider offering services, goods for rent and sale or property for rent, and as a client in need of services, goods to rent or buy or property to rent. The software program further maintains an identification information and a bank account and a credit card information of the users in the database.

The software program maintains a list of offered services, goods for rent or sale, or property for rent associated with the offering provider; and lists the offered services, goods for rent or sale, and property for rent in response to a client in need of services, goods to rent or buy, or property to rent.

The software program further provides characteristics provided by the provider of services, goods for rent or sale or property for rent as to type of the services, goods or property, required eligibilities of the client bidding for the services, goods or property, delivery and collection location, duration and price for the services or for rent or sale of the goods or rent of the property. The software program further provides the virtual storefront for the provider and the client to negotiate the transaction involving the services, goods or property.

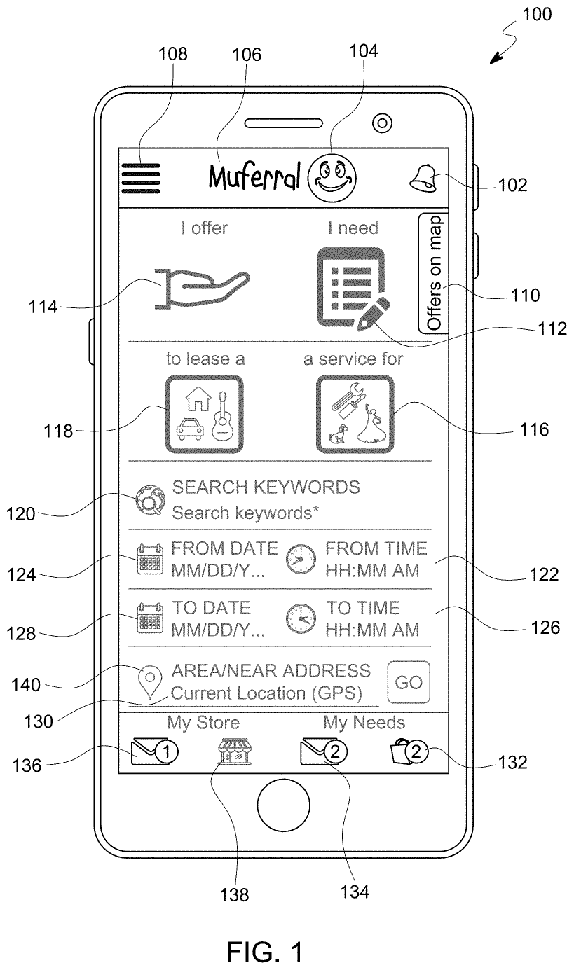

As to the presented figures, FIG. 1 shows an example of a landing page of the software application. The landing page 100 is shown with a notification 102 bell shaped icon, a software application smiley face logo 104, “Muferral” 106 as the name of the software application, and a hamburger stack 108. Furthermore, an “Offers on Map” 110 icon, an option button “I offer” 114 and corresponding option button “I need” 112 are shown. An option button “to lease a” 118 and corresponding option button “a service for” 116 are also shown along with a “Search Keywords” 120 icon. Furthermore, a “FROM DATE” 124 icon, a “from time” 122 icon, a “TO DATE” 128 icon, a “TO TIME” 126 icon, an “AREA/NEAR ADDRESS Current Location (GPS)” 130 icon, and Map icon 140 are shown. At the bottom of the page under “My Needs” a bag 132 including a list of bids for offers and an envelope 134 including messages for the client is shown. Additionally at the bottom of the page under “My Store” a storefront 138 icon including the offers provided by the registered user, and an envelope 136 including messages for the provider is shown.

As is illustrated on the landing page 100, any user can be both a provider and a client. The icons at the bottom of the page covering “My Store” and “My Needs” include items that the user has a bid on them and items that are offered and the associated messages with both offers and bids for the user.

On the landing page 100, tapping on the “Offers on Map” 110 icon opens up an “AVAILABLE OFFERS” map page (not shown) with the user position identified on the map and showing location of items and services on the map. On the upper right-hand side of the “AVAILABLE OFFERS” map page a funnel shaped icon is provided indicating a filtering option. By tapping on the funnel icon user can filter presented offers on the “AVAILABE OFFERS” map page as to item or service or both and according to an item or service specified by a search keyword for specific availability date and time and proximity to an area, address, or user's current location. The client can limit a search area for available offers on the map by drawing a boundary around an area of interest on the map displayed on the smartphone screen.

On the landing page 100, tapping on the logo 104 opens up a chat window to seek help from an operator on any issue related to functions of the software application. Furthermore, after entering a location on the AREA/NEAR ADDRESS 130 icon, by tapping on the Map icon 140 a map of the rea opens up and by moving the map around a pin the area of interest can be pinpointed as the desired location.

Following steps detail the initial registration of user with the software application. Upon downloading the software application, the user sees the landing page 100 and a series of animated windows describing the general functions of the software application. In order to register with the software application Muferral 106, the user clicks on hamburger stack 108 and a pull-down menu (not shown) opens up that includes a “sign up” icon.

As for the initial registration process, the process of registration includes the user providing personal identifying information comprising user name, address, government issued identification numbers, and birth date; and financial information comprising bank account information, credit card information, other financial institutes information, authorization for deposit and withdrawal from the financial accounts, and establishing a wallet enabling making payments and receiving funds.

After clicking on the hamburger stack 108 on the upper left-hand side of the landing page 100, the user clicks on “sign up” icon from the pull-down menu (not shown). User next enters her email address as requested, and clicks on submit. Then user enters name, middle name, last name, nick name, date of birth, password and confirms password, country and zip code, cell phone number and then user clicks on continue.

Next, the user is asked for permission to take photos and videos using the smartphone camera and also asked for permission to access the smartphone photos. Then software application enables the user to take front and back photos of user legal identification document (ID) such as a driver license in addition to a photo of an alternative ID. The software application can initiate taking two photos of the legal ID, one with a flash and one without flash. The two photos are complimentary and provide clarity on areas that may not be visible in either of the photos due to lack of light or reflection of the flash light from some parts of the photos. The software application does not allow any uploading of existing photos or videos, except for uploading a business logo. All images and videos requested by the software application shall be captured real time. Next, user clicks on “SIGN UP” icon. The Muferral 106 software applications allows for accessing photos and videos on the smartphone for business logo, however for user authentication of goods, services and property description via photos or videos, Muferral requires real time photos and videos captured using device camera and does not allow using preexisting images that may have been altered through access to preexisting images.

Next, Muferral 106 software application sends a verification code to the email and a text to the phone number to verify the email address and phone number through entering the verification codes on the verification window that opens up (not shown).

Upon approval of the entered information by the software application, the user is registered with the Muferral application.

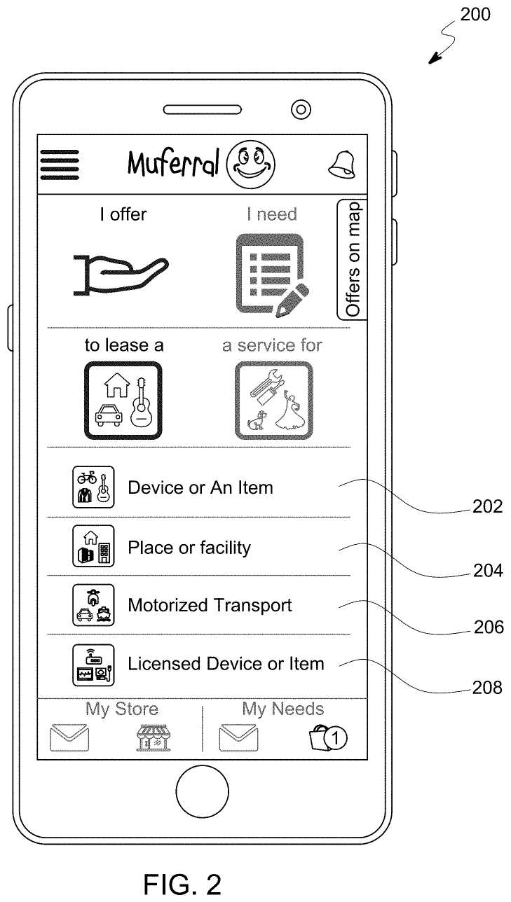

As to the presented figures, FIG. 2 shows an example of a provider offering goods for rent and sale and property for rent page. The provider offering goods and property page 200 shows a “Device or An Item” 202 icon, a “Place or Facility” 204 icon, a “Motorized Transport” 206 icon, and a “Licensed Device or Item” 208 icon.

Following steps provide a sample Muferral 106 software application use when a user is a provider offering a guitar as a musical instrument goods for lease or sale.

A registered user picks the options of “I offer” 114 and “to lease a” 118, followed by the option “Device or An Item” 202 and confirms her choice by clicking on radial button “GO” on the “DEVICE OR AN ITEM” page (not shown) that opens up. At this point User is a provider.

A follow-on page (not shown) opens up to provide information relating to the “DEVICE OR AN ITEM” including “ITEM INFORMATION”, “OPTIONS AND FEATURES”, “PRICE”, “DELIVERY OPTIONS”, “RETURN OPTIONS”, and further options for “AVAILABILITY”, “BOOKING METHODS”, “TRY BEFORE BUY”, “ADD-ONS”, “CAUTIONS”, “OTHER CHARGES & POLICY”, “DIMENSIONS”, “PREFERENCES”, and “MUFERRAL PROGRAM”. An approved submitted offer will have an icon labeled “Deactivate the offer” for deactivating offers for any reason including if there are no current or future bookings by a client. After deactivating an offer there would be a further option to delete the offer.

Upon selecting “ITEM INFORMATION” on the new page (not shown), provider populates a plurality of fields where a tag upon each entry blank space provides explanation as to what information the entry will provide.

Under “Title” provider enters “Guitar” as the title of her offer profile and what to come up in a search.

Under “Description” provider enters “Electric Guitar” to describe the offer.

Under “Category” provider enters “Musical Instruments” from a pick list. Categories can be suggested and added by users.

Provider next uses Muferral application to “Take Photos” and/or “Take Videos” of the Guitar to include with the information.

Provider then continues with providing information as to “Make”, “Model”, “Year” built, “Color” and “Serial #” of the guitar if applicable.

Provider next enters an “Owner estimated value (USD, US Dollars)” for the guitar. The currency used may be the currency of the country of the user or where the information is entered.

Provider next chooses to have the guitar shown under provider profile or not.

Provider next will indicate if the guitar needs to be tamper proof, in which case Muferral application administer will arrange for a tamper proof label to be mailed to the provider to be placed on the guitar. In general tamper proofing concept is used for detachable parts of an item, an acoustic guitar may not need such a tamper proof label, but an electric guitar with a detachable pickup system may need such a temper proof label.

Provider next indicates if a license is required for booking of the guitar, and if required a text box will open up for identifying the required license.

Provider next provides an address for location of the guitar if guitar is to be picked up, otherwise if the guitar will be shipped to whomever will be renting or buying it then no address will be displayed on the offer.

Provider next clicks on the upper right-side checkmark on the page to save and exit “ITEM INFORMATION” page.

Provider next clicks on “OPTIONS & FEATURES” on “DEVICE OR AN ITEM” page (not shown) and picks “Available options and features” from a pull-down menu, and identifies if the chosen options are available or not or if they are not applicable to the guitar.

This template for “DEVICE OR AN ITEM” has the ability to create “Attributes” for both the client information and also search purposes. Attributes are those characteristics that are not in the category of Options and Features. For example, for a guitar the Attribute would be “Neck length 22.5 inches” or for a pair of pants Attribute would be “Size 31 inches”, “31” or for a camera lens the Attribute would be “Aperture 1.2”. Provider has the ability to define the characteristic label and its value for an attribute.

Provider next clicks on “PRICE” on “DEVICE OR AN ITEM” page and enters a price “Per hour (USD)” or “Per day (USD)” for renting the guitar. The currency used may be the currency of the country of the user or where the information is entered. Provider has the option to enable an option for clients to proffer a price to be reviewed by the Provider for acceptance. Upon saving the “PRICE” by clicking on the upper right-hand checkmark the Provider can reenter the “Price” page and “ADD DISCUNTS” to be used by the client based on the time duration the guitar is leased either on a dollar per Hour or day or on a price percentage based. There is also an option for customized pricing.

Provider next clicks on “DELIVERY OPTION(S)” on the “DEVICE OR AN ITEM” page, and clarifies “if the delivery time is part of the rental offer”, chooses shipping method of FedEx (Federal Express), UPS (United Parcel Service) ground delivery, USPS (United States Postal Service) ground delivery (depending on the country or region the carriers may be different) (all to be paid by the client); within a specific radius (Miles, or Kilometers) or within the city or state or nationwide; alternatively delivery may be local pickup, or Provider dropping off at a location specifying a charge amount (USD) within a specific radius (Miles), or drop off at Half a way/another location, within the city, within the state or within nationwide.

Provider next clicks on “RETURN OPTION(S)” on “DEVICE OR AN ITEM” page and pick a return option for the guitar similar to the options available for delivery.

Note that information provided up to this point are mandatory fields to be populated. After this point, the rest of the fields are optional and can be filled out later and are not required to submit the offer. Once the offer is submitted, the provider reads the disclaimer and checks the Terms and Conditions. The offer will then be reviewed by the support team of the Muferral 106 software application. Once the offer is reviewed and it is placed in the right category, the offer will be approved or it will be rejected to be resubmitted.

Provider next clicks on “AVAILABILITY” on “DEVICE OR AN ITEM” page to identify an available time period for leasing the guitar as a future number of days duration or a specific time duration between two dates, identifying a minimum and maximum lease duration of booking in days, pick up and return time of the day, minimum number of waiting days before guitar can be leased for each new lease agreement, establishing a minimum eligibility rating for a client based on past rental experience history of the client, and a minimum age limit for a client eligible to lease the guitar. The Muferral application administrator can set a minimum age in AVAILABILITY so the provider can only specify eligibility ages older than the minimum age.

Provider next clicks on “BOOKING METHOD” on “DEVICE OR AN ITEM” page to choose between “Instant Booking” or “Booking by request”.

Provider next clicks on “TRY BEFORE BUY” on “DEVICE OR AN ITEM” page to indicate if client has the option to buy the guitar after leasing the guitar. If this option is available for client, then a sale price and potential discount based on what client has paid for lease up to the point of client decision to buy the guitar is indicated. Furthermore, Client is advised on potential sales tax payment requirement.

Provider next clicks on “ADD-ONS” on “DEVICE OR AN ITEM” page to add a new add-on if available and applicable. An ADD-ON can be an item or a service itself.

Provider next clicks on “CAUTIONS” on “DEVICE OR AN ITEM” page to provide notes of caution applicable to the guitar to potential clients. Some caution notes such as late fees, cancellation, and eligibility requirements are automatically populated.

Provider next clicks on “OTHER CHARGES & POLICY” on “DEVICE OR AN ITEM” page to identify additional charges and notes including required “DEPOSIT”, “LATE FEE”, “CANCELLATION POLICY”, “CLEANING” fee, “REPACKAGING” fee, or any other fee.

Provider next clicks on “DIMENSIONS” on “DEVICE OR AN ITEM” page to identify weight, size for the guitar and shipping weight and size for the guitar.

Provider next clicks on “REFERENCES” on “DEVICE OR AN ITEM” page to allow full item (guitar) and provider profile display, allow partial information display, or hide item (guitar) and provider profile display, further to allow or not allow clients to send messages to provider inquiring about the item (guitar), establishing the language of the offer that may be different from provider language, establish notification characteristics as to default setting or custom setting for push notifications to be silenced, and text messages for transactions, reminders, and delivery updates, and including additional user IDs for notifications to other users.

Provider then clicks on “MUFERRAL PROGRAM” on “DEVICE OR AN ITEM” page to activate a Muferral Reward Program by identifying another user ID who helped the provider in setting up the offer for leasing the guitar. Upon this activation both the helping user and the offering provider of the lease of guitar each will get an additional 2% of the rental payout credited to their wallet. This designation is perpetual and is not transferable.

Upon completing all the steps, the provider will agree to the terms and conditions governing transactions initiated through Muferral and submit the offer to be available through the Muferral 106 software application.

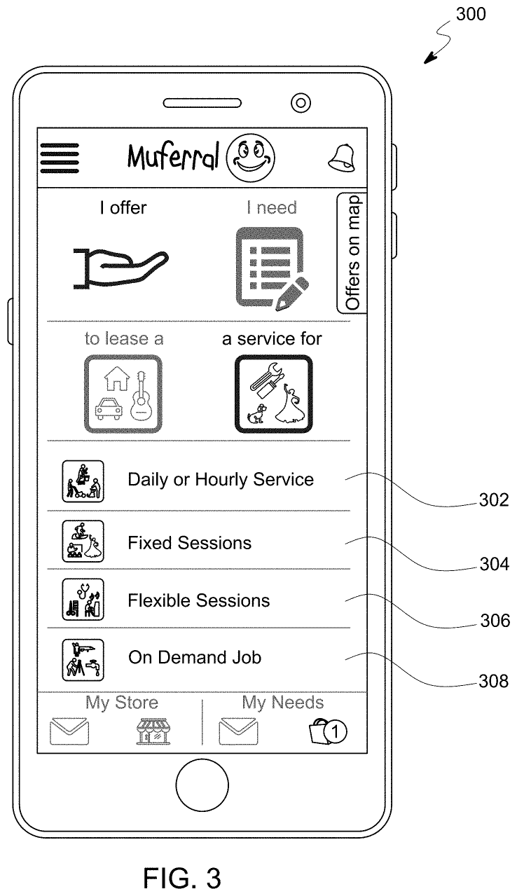

As to the presented figures, FIG. 3 shows an example of a provider offering a service page. The Provider offering a service page 300 shows a “Daily or Hourly Service” 302 icon, a “Fixed Sessions” 304 icon, a “Flexible Sessions” icon, and an “On Demand Job” icon.

Following steps provide a sample Muferral 106 software application use when a user is a provider offering a service of plumbing. The following sample is for services that have an “On Demand Job” 308 schedule.

A registered user picks the options of “I offer” 114 and “a service for” 116, Identifying herself as a provider.

The provider next Clicks on “On Demand Job” 308 from the options of the “Daily or Hourly Service” 302, “Fixed Sessions” 304, Flexible Sessions” 306, or “On Demand Job” 308 to identify available times for the service. The options for availability of a service are: “Daily or Hourly Service” 302, “Fixed Sessions” 304, Flexible Sessions” 306, and “On Demand Job” 308. Some examples for “On Demand Job” 308 include Plumber, wedding photographer, and any repair services.

Next, Muferral 106 software application opens a page (not shown) describing the option of “ON DEMAND JOB” 308 for the provider to click on “GO” to proceed.

Next, Muferral application opens a webpage (not shown) “ON DEMAND JOB” 308 listing options for entering detailed information on the offered service including “SERVICE INFORMATION”, “PRICE & AVAILABILITY”, “DELIVERY OPTION(S)”, “CAUTIONS”, “CENCELLATION POLICY”, “PREFERENCES”, and “MUFERRAL PROGRAM” for the provider to populate with information.

Next, provider clicks on “SERVICE INFORMATION”, and Muferral application opens the page (not shown) “SERVICE INFORMATION”.

The “SERVICE INFORMATION” page includes following entry spaces with an option on each detailing what goes into each space: “Title”, “Description”, “Category”, “Take Photo(s)”, “Take Video(s)”, “Show this offer under my profile”, “Please choose the location of the service”, and a “Note” we don't show the exact address unless if it is needed only in the booking confirmation.

Next, provider enters “plumbing” under “Title”, enters “commercial and residential plumbing service” under “Description”, clicks on “Category” to open a pull-down list and picks “Repair and Maintenance” and from a sub-list picks “Plumbing”. Here again categories can be suggested and added by users.

Next, provider takes photos and videos of some advertising pamphlets representing the plumbing service for her plumbing offer, and maintains the check mark on “Show this offer under my profile”.

Next, as for the location of service, provider enters an address to identify a geographical location for the plumbing service, and clicks on the upper right corner checkmark on the page to complete “SERVICE INFORMATION” entries. Muferral application opens a window indicating “Muferral Service information saved successfully, and provider clicks on OK. Muferral will not share that exact address with the client if the client will not physically get the service at that location and basically the address is not needed, for the offeror's confidentiality. The area around the physical address, however, is shown publicly for all offers including items on the offeror's profile.

Next, provider clicks on “PRICE & AVAILABILITY” on the “ON DEMAND JOB” and Muferral 106 software application opens the “PRICE & AVAILABILITY” page (not shown) including a space to enter a “Flat Rate (USD)” (the currency used may be the currency of the country of the user or where the information is entered) price and options to activate “Please check if you accept reviewing offers” to enable clients to offer prices for the service, “This offer requires final price adjustment” in case the specified price is a best guess estimate and depending on conditions provider wants to have the option to change her service price, and “Eligibility is required for this booking” in addition to “Please specify the age limit for this booking (if applicable). The Muferral 106 software application administrator can set a minimum age in AVAILABILITY so the provider can only specify eligibility ages older than the minimum age. Provider establishes a rate of 75 USD and does not check any other options on the page and sets the age limit for the booking as minimum age identified by the software application, and clicks on the upper right-hand side checkmark to finalize entry on this page. Muferral 106 software application opens a window (not shown) indicating Price and availability saved successfully and provider clicks on OK.

For the “ON DEMAND JOB” 308 the Price and Availability are combined in one menu since “ON DEMAND JOB” 308 elements are simpler.

Next, Provider clicks on “DELIVERY OPTION(S)” and corresponding page (not shown) opens providing options for “Through internet or phone”, “Local Service” requiring specifying the area of service within a radius defined by miles or a half way location between the provider and client, within the city, within the state, or within nationwide. Provider checks the option for “please choose the area of your service at the client location” and “Within the city” and clicks on the upper right-hand check mark on the page and then OK to complete entry on this page.

Up to this point the fields to populate for the ON DEMAND JOB 308 are mandatory fields for providing an offer for a service.

Provider provides following entries: for “CAUTIONS” “Please inform if there are any animals at the job site”, for “CANCELATION POLICY” “50 USD” as for a cancelation charge. Cautions are shown as direct notes from the offeror by adding a text or showing the information already filled up by the offeror such as availability for eligible users, and age restrictions. Some caution notes such as late fees, cancellation, and eligibility requirements are automatically populated.

For “PREFERENCES” detailing how the offer will be shown and in what language and what specific notification process, provider picks “Show complete item profile DEFAULT” as for language provider picks “Use account setting (Default)” and for “Notification” provider picks “Use account settings (Default), provider does not provide any entries for “Use custom settings” and for “also send notification to the below users”. Provider next clicks on the upper right hand check mark on the page and clicks on OK on the window indicating “Preferences saved successfully” to save the entries. For “MUFERRAL PROGRAM” identifying another user ID so that provider and the other user each get 2% extra from each booking. Once the Muferral Reward Program is activated, Muferral application shows the program is activated without showing the other User's ID who has been identified by the provider. The recipient of the other user's 2% payment can be a cause. The cause will be visible and identified and the recipient cause can be changed. The recipient can be changed to a user, however if assignment is to a user, the user cannot be changed.

Provider clicks on “NEXT” on the “ON DEMAND JOB” page, and clicks on “I Agree to the Terms & Conditions” on the next page that opens and “SUBMIT” the offer, upon which the Muferral 106 software application acknowledges that Service submitted successfully for the provider to click on OK.

Following steps provide a sample Muferral 106 software application use when a user is a provider offering a service of guitar class. The following sample is for services that have a “Flexible Sessions” 306 schedule.

A registered user picks the options of “I offer” 114 and “a service for” 116, Identifying herself as a provider.

The provider next Clicks on “Flexible Sessions” 306 from the options of “Daily or Hourly Service” 302, “Fixed Sessions” 304, Flexible Sessions” 306, or “On Demand Job” 308 to identify available times for the service. The option of “Flexible Sessions” 306 is of providers who know the duration of their work time but the client can choose it on the calendar based on mutual availability of provider and client.

Muferral 106 opens up the FLEXIBLE SESSIONS page (not shown) and Provider next clicks on “SERVICE INFORMATION”.

Under “Title” provider enters Guitar class.

Under “Description” provider enters “training classes for beginner and advanced classical guitar players.”

Provider clicks on and opens the “CHOOSE A CATEGORY” page and clicks on “Classes and Training” and then clicks on “Music” and then clicks on “String” and finally clicks on “Guitar”.

Provider then takes photos and videos describing the guitar classes and clicks on upload to Muferral 106.

Provider then maintains the check mark on “Show this offer under my profile”.

For location of the service Provider clicks on the + sign to enters an address after entering her password in a new window, or picks an existing address associated with her account, in present case an existing address in Irving Texas is picked by the provider.

Provider next clicks on the upper right hand side check mark of the “SERVICE INFORMATION” page (not shown) to save the service information, and clicks on OK on the window confirming the “service information saved successfully.”

Provider next clicks on “PRICE” on “FLEXIBLE SESSION” page (not shown).

On the “PRICE” page (not shown) provider enters 25 in the “Per hour (USD)” entry space, and maintains the check mark on “your offer will be calculated as hourly” and does not check the “Please check if you accept reviewing offers” and “This offer requires final price adjustment” and clicks on the upper right hand check mark on the “PRICE” page for Muferral 106 software application to exit the “PRICE” page. Provider can reenter the “PRICE” page and click on “DISCOUNT” to specify % discount based on number of sessions booked, or “CUSTOMIZE PRICE ON CALENDAR” by specific date range and specifying minimum hours booked, or based on specific weekdays within a specific starting and ending dates, followed by specifying the new hourly price for the specified rules.

Provider next clicks on “DELIVERY OPTIONS” opening the “DELIVERY OPTION(S)” page (not shown). Provider can check the “Through the internet, voice/video calls and etc. . . . .” This makes your service to be available globally in different time zones based on the provider's local time. Or provider can check “Local Service” for providing the service at the location the service provided. Alternatively, provider can check the icon for choosing the area of the service at the client location, for which provider specifies a rest period (as minimum advance notice before any booking), any associated additional charges and indicates the location to be within a specified radius in miles, or half a way/another location, within the city, within the state, or within nationwide. Provider picks through internet or phone. And clicks on the upper right hand side check mark on the page, upon which a window opens up confirming Delivery Option saved successfully for provider to click on OK.

Up to this point the entries on the “FLEXIBLE SESSIONS” were required and mandatory to enable the offer, remaining entries, which are not mandatory and required, include “AVAILABILITY” outlining when the service is available for booking, if eligibility is required for the booking and age limits for the booking, The provider sets the age limit eligibility, however the Muferral application administrator can set a minimum age in AVAILABILITY so the provider can only specify eligibility ages older than the minimum age. the rating eligibility is established by the client user gaining certain ratings as more reliable users with a rating of 4.5 with at least 10 ratings; “BOOKING METHOD” allowing for instant booking or booking by request allowing the provider to review the booking before acceptance; ADD-ONS” allowing for provider to list any add-on available for the service specifying associated price either as per hour or flat rate per booking or a onetime charge, and maximum inventory/quantity available for the offer; “CAUTIONS” for provider to list any specific concerns or cautions related to the offer or as it relates to the client booking the service; “CANCELLATION POLICY” as to if a refund is available or not after a specified time period post booking; “PREFERENCES” for specifying how the offer can be seen with what level of detail, if a message button will be available for the offer, what language is used for the offer as to account setting or custom setting, what method of notification to be used with the options of account setting or custom setting, push notification or no notification (silent), text messages for transaction, reminders or delivery updates, through email and the option to send notification to additional users used for keeping track of bookings elsewhere outside Muferral software application; and the “MUFERRAL PROGRAM” used for identifying a referring user so the identified user can get a percentage of the booking fees for their referral of the provider. Since these entries are not mandatory and required for the provider to complete, the provider clicks on “NEXT” to go to a “DISCLAIMER” page (not shown), and agrees to the Terms & Conditions and clicks on SUBMIT for a window indicating Service submitted successfully to open and provider to click OK on the window (not shown).

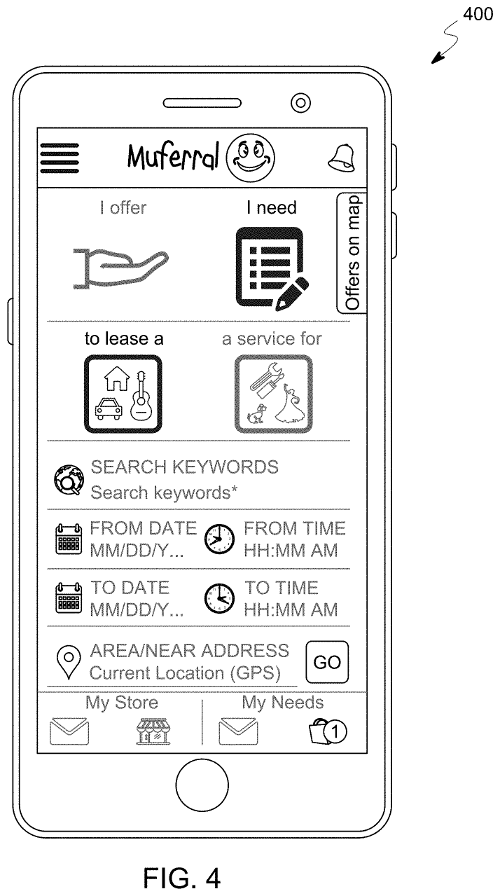

As to the presented figures, FIG. 4 shows an example of a client needing goods for rent or buy and property for rent page. The client needing goods or property page 400 shows the same landing page 100 on FIG. 1, with the “I need” 112 option button and “to lease a” 118 option button activated.

Following steps provide a sample Muferral 106 software application use when the user is a client in need of leasing a guitar as a musical instrument goods.

A registered user picks the options of “I need” 112 and “to lease a” 118, Identifying herself as a client.

The client then types electric guitar in the “SEARCH KEYWORDS” 120, the Muferral 106 confirms the search word of “guitar” depending on available listing. Client clicks on Guitar or types more words to narrow down the search and Muferral 106 software application brings back the main landing page 400.

Client can pick a date and time on “FROM DATE” 124 and “FROM TIME” 122 and the same on “TO DATE” 128 and on “TO TIME” 126; however, picking specific times will limit the search option. Muferral can use the entered dates to narrow down the search.

Client then clicks on AREA/NEAR ADDRESS 130 to enter an address. Client enters Dallas and from the choices provided picks Dallas, Tex., USA. Muferral application returns to the main landing page 100 with the address identified, and client can click on “GO”. Client can click on the map icon 140 next to the address box 130 and move the center of search area on a map that opens up manually to fine tune the desired address location.

If there is no guitar available in that time period or in that locality, or if one is not available for shipping then system will indicate no item available around this area and radius. otherwise Muferral 106 software application provides a listing of guitars available for lease or sale with price and distance from geographical location indicated.

The page (not shown) further provides features such as “View on map” where the locations of available guitars are shown on a map.

Another feature on the page (not shown) enables the client to search for “Similar service(s) available” where other similar offering for the goods (in our case a guitar) will be listed.

There is an icon on the bottom of the page (not shown) identifying “Try Before Buy” (TBB). The TBB (Try Before Buy) icon will not be shown if none of the items shown has the TBB option enabled by the provider, or if the items are services.

At the top of the page (not shown) there are two icons. One is “SORT” and the other is “FILTER”. Clicking on “SORT” opens a window specifying the sorting of the available offers can be based on “Rating”, “Distance”, “Price: Low to High” and “Price: High to Low” the sorting action can then be picked to “Apply” or “Cancel”.

Clicking on the “FILTER” will open a page (not shown) with the following options for filtering the available offers: Delivery Method of “Local Pick Up”, “USPS Ground Delivery”, “FedEx Overnight”, “UPS Ground Delivery”; Return Method of “UPS Ground Delivery”, “USPS Ground Delivery”, “Fedex Overnight”, and “Local drop off”; Price (an adjustable range from Min (0 USD) to Max (5000 USD+), and Distance from Min (0 mi) to Max (5000 mi+); and the option of “Try Before Buy”. The filtering then can be picked to “CANCEL” or “APPLY”. The filter items are shown depending on the results. For example, if none of the items have “UPS Ground Delivery”, the “UPS Ground Delivery” option for filtering will not appear in the filter. TBB checkbox will appear if there is such an item in the result.

Client then clicks on one of the guitars offered by the Muferral 106 software application.

Next, the Muferral 106 software application opens a page (not shown) providing photos and detailed information “INFO” on the chosen offered guitar, The page further includes “SPECS” detailing specification on the guitar, and “CAUTIONS” providing related information as to minimum required age, cancellation policy and restrictions on use of the guitar and similar cautions provided by the provider as it relates to the guitar.

Client next clicks on “Book it now” icon located on the photo of the guitar, or through the calendar icon and then choose booking icon, and Muferral 106 software application opens a window (not shown) detailing “Session duration”, “Start time”, “End time” and associated “Limitations” with the offer or any necessary notes regarding the offer before a client considers booking it. Client will indicate agreement with the terms by clicking on “OK”.

Next a calendar page (not shown) opens up indicating available times for lease of the guitar, enabling Client to pick a duration for the lease that is available as indicated on the calendar, and clicks on the check mark on the upper right-hand side of the page. The Guitar will be placed on the client “Cart” to be processed.

Next Muferral 106 software application opens a page (not shown) identifying “ADD-ONS” for the guitar for client to add to her order, where Client can “SKIP” or “CONTINUE” following accepting some of the “ADD-ONS”.

Next Muferral 106 software application opens a “DELIVERY” page (not shown) where client can choose delivery or pick up option. A “RETURN” page (not shown) then opens up where client chooses return option.

Next page is “CONFIRM BOOKING” page (not shown) where client can “SEND REQUEST” to finalize Client action waiting for approval from the offeror. Some offers are set to ‘instant booking’ by the offeror or provider which can be booked immediately. Depending on the offeror setting for this offer, clients can send a bid for a bargained price and upon the offeror approval they can check out the offer from the cart.

Once the final booking is done the booking from the cart will move to the “My Needs” 132, Orders for the client and it will show under “My Store” Bookings 138 for the offeror.

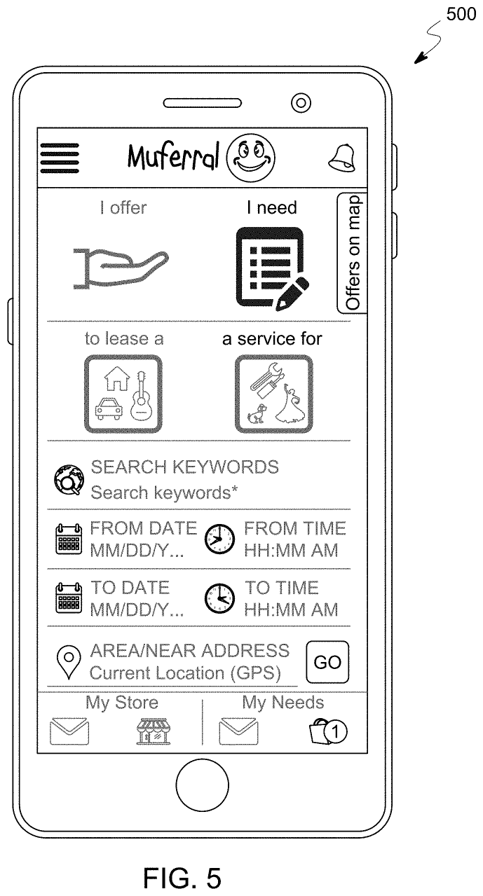

As to the presented figures, FIG. 5 shows an example of a client needing a service page. Client needing a service page 500 shows the same landing page 100 on FIG. 1, with the “I need” 112 option button and “a service for” 116 option button activated.

Following steps provide a sample Muferral 106 software application use when the user is a client in need of a service of guitar classes.

A registered user picks the options of “I need” 112 and “a service for” 116, Identifying herself as a client.

Client next enters guitar classes under “SEARCH KEYWORDS” 120 and clicks on Muferral 106 software application suggested term “Guitar Classes” to go back to the main page 500.

Client then can identify date and time to start and end the duration of need which will limit the available options the Muferral 106 software application can search. Muferral 106 software application can use the entered dates to narrow down the search. Client can also identify an “AREA/NEAR ADDRESS” 130 to further limit the search by Muferral 160 software application. Client can also tap on the “Map icon” 140 next to the address box 130 and move the center of search area manually on the map window that opens up (not shown) to fine tune the desired address location. In our case Client will not identify date and time, but will identify Irving, Tex. and clicks on Muferral 106 software application suggested Irving, Tex., USA as for location, and clicks on “GO” to further the search for the guitar classes. The client can limit a search area for available offers on the map by drawing a boundary around an area of interest on the map displayed on the smartphone screen.

Muferral application provides the available services. Client can filter and narrow down, sort or even see online offers for that service offered globally regardless of the location of the offer. Client clicks on one of the available services and a page (not shown) detailing the service opens up, and client clicks on “Book it now” icon on the photo to book the service. Muferral 106 software application opens a window detailing session duration, available times, and other limitation for the client to accept by clicking on “OK”.

Next a calendar opens (not shown) for the client to pick service date desired. Client picks a date and start and end time for a one-hour duration. Muferral 106 software application identifies the session time in a page (not shown) titled “SESSIONS” for client to click on “CONTINUE” with an option to “ADD MORE”. Client clicks on “CONTINUE”.

Next Muferral 106 software application opens a page (not shown) titled “DELIVERY” with options for “Online”, “Local Service”, and “Client Location” Within State of TX. Client picks “Online” and “CONTINUE”.

Next a “CONFIRM BOOKING” page (not shown) opens detailing the service, cost, and “Cancellation Policy” for client to click on “SEND REQUEST”.

Depending on the offer, ADD-ONS can also exist for the searched service in the form of an item or service. For example, Guitar class with tea, breakfast, or other ADD-ONS.

Next, a page (not shown) titled ‘MY NEEDS” opens up showing all client bookings including the Guitar Classes on the top of the page as pending.

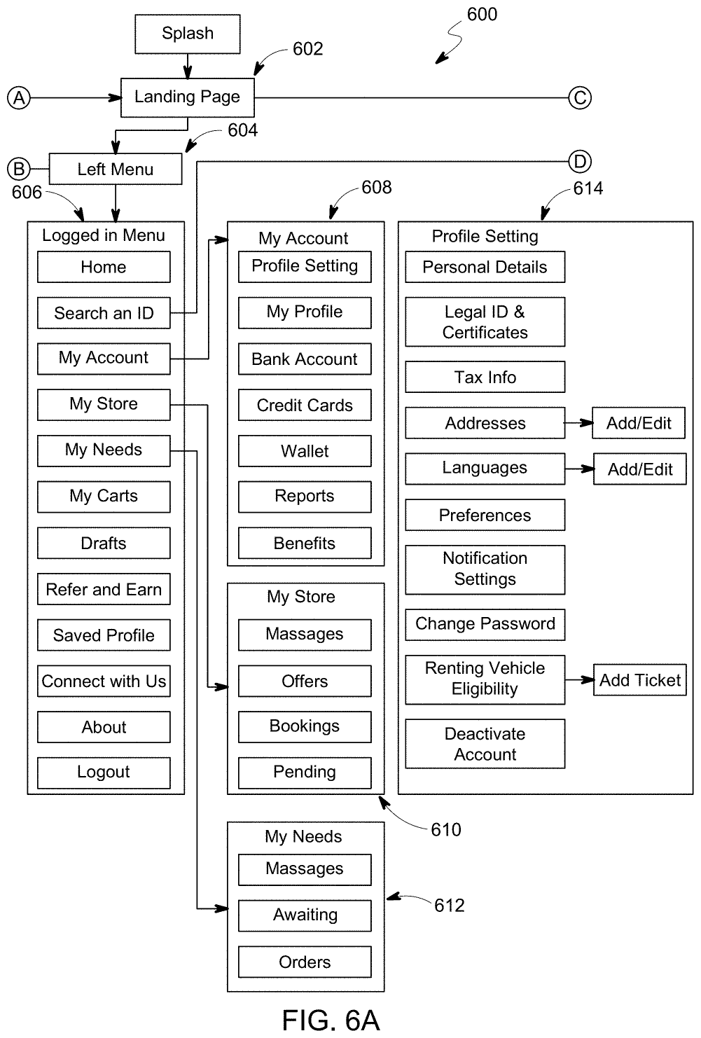

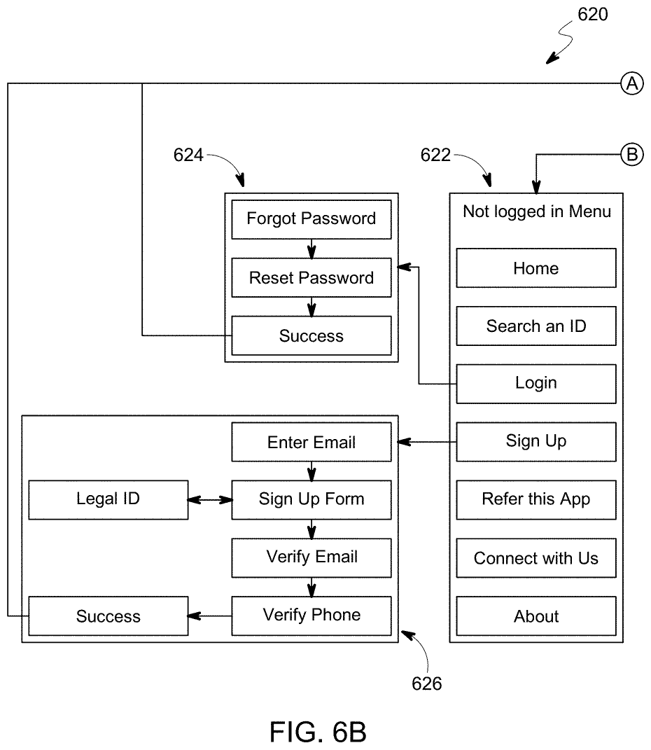

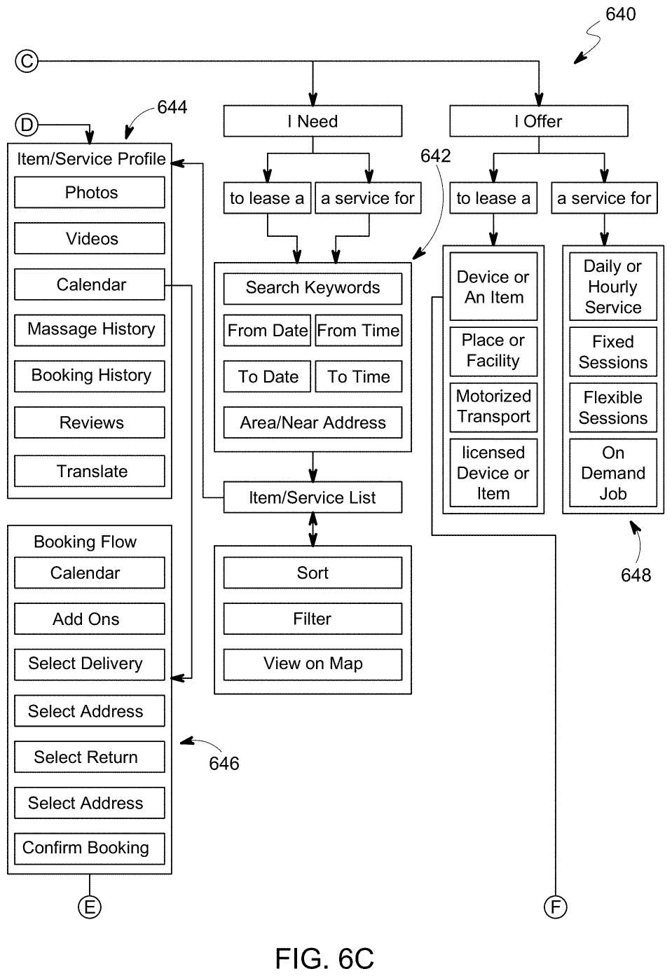

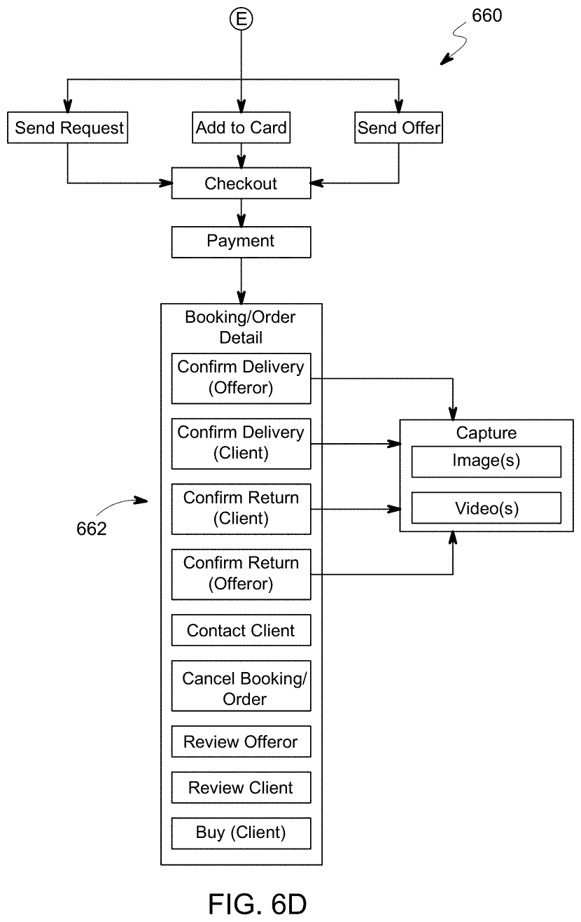

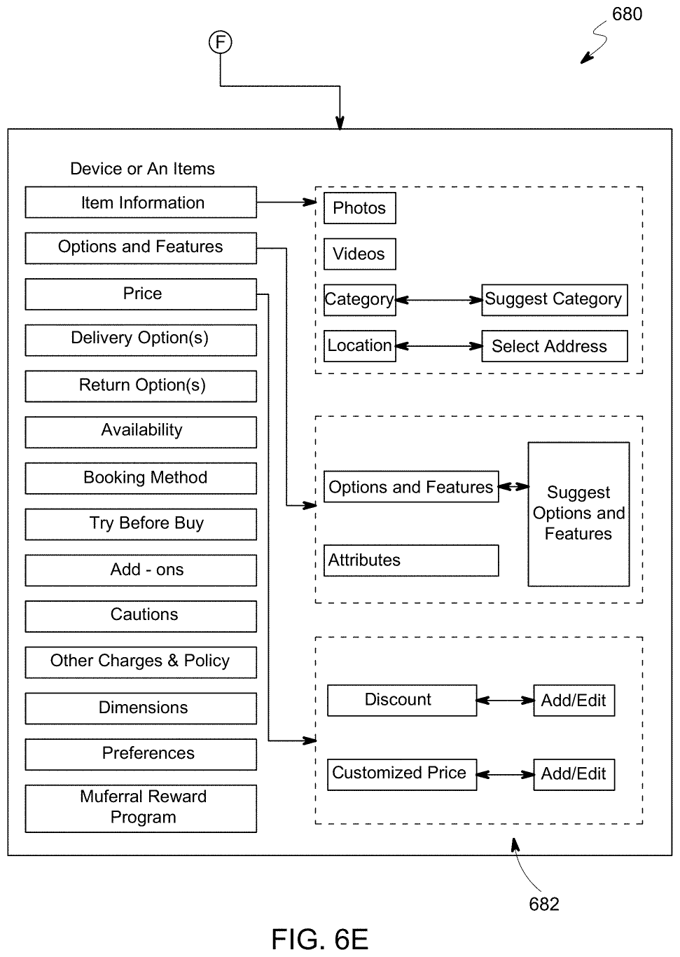

As to the presented figures, FIG. 6A shows a first subsection of an example of a schematic functional interrelation flowchart diagram. The first subsection of the schematic functional interrelation flowchart 600 further shows a general category of initial functions when a user opens up the Muferral 106 software application. Functions include “splash” and “landing page” 602, “left menu” 604 leading to “logged in menu” 606 function group further including functions of “home”, “search an ID”, “my account”, “my store”, “my needs”, “my carts”, “drafts”, “refer and earn”, saved profile“, “connect with us”, “about” and “logout”.

The general category of initial functions further includes the following: the “my account” 608 function group including “profile setting”, “my profile”, “bank account”, “credit card”, “wallet”, “reports”, and “benefits”; the “my store” 610 function group including “messages”, “offers”, “bookings” and “pending”; the “my needs’ 612 function group including “messages”, “awaiting” and “orders”.

The general category of initial functions additionally includes the “profile setting” 614 function group including “personal details”, “legal ID & certificates”, “tax info”, “addresses” including “add/edit”, “languages” including “add/edit”, “preferences”, “notification settings”, “change password”, “renting vehicle eligibility” including “add ticket”, and “deactivate account”.

On FIG. 6A there are four connection links to and from FIGS. 6B and 6C labeled as (A), (B), (C) and (D).

As to the presented figures, FIG. 6B shows a second subsection of an example of a schematic functional interrelation flowchart diagram. The second subsection of the schematic functional interrelation flowchart 620 further shows a “not logged in menu” 622 function group further including “home”, “search an ID”, “log in”, “sign up”, “refer this app”, “connect with us”, and “about”. Furthermore, the second subsection of the schematic functional interrelation flowchart 620 shows a “login password” 624 function group including “forgot password”, “reset password”, and “success”; additionally, a “sign up” 626 function group is shown including “enter email”, “sign up form” including “legal ID”, “verify email”, and “verify phone” including “success”. On FIG. 6B there are two connection links connecting to FIG. 6A labeled as (A) and (B).

As to the presented figures, FIG. 6C shows a third subsection of an example of a schematic functional interrelation flowchart diagram. The third subsection of the schematic functional interrelation flowchart 640 further shows function groups including “I need” 642 function group. “I need” 642 function group includes “I need”, “to lease a”, “a service for”, “search keywords”, “from date”, “to date”, “from time”, “to time”, “area / near address”, “item/service list”, “sort”, “filter”, and “view on map”.

The function groups further include “item/service profile” 644 function group including “photos”, “videos”, “calendar”, “message history”, “booking history”, “reviews”, and “translate”. Another included function group is “booking flow” 646 function group including “calendar”, “add ons”, “select delivery”, “select address”, “select return”, “select address” and “confirm booking”. The “confirm booking” is linked to FIG. 6D via connection link called (E).

The third subsection of the schematic functional interrelation flowchart 640 further shows function groups including “I offer” 648-function group, including “I offer”, followed by “to lease a”, “device or an item”, “place or facility”, “motorized transport”, and “licensed device or item”; and also followed by “a service for”, “daily or hourly service”, “fixed session”, Flexible sessions” and “on demand job”. The sections following “to lease a” as a group in linked to FIG. 6E via link identified as (F).

The third subsection of the schematic functional interrelation flowchart 640 also shows a plurality of linked lines to FIGS. 6A, 6D and 6E identified as (C), (D), (E) and (F).

As to the presented figures, FIG. 6D shows a fourth subsection of an example of a schematic functional interrelation flowchart diagram. The fourth subsection of the schematic functional interrelation flowchart 660 as linked to FIG. 6C via link (E), further shows functions groups including “send request”, “add to cart” and “send offer” leading to “checkout” and “payment” followed by “booking/order detail” 662 function group. “Booking/order detail” 662 function group further include “confirm delivery (offeror)”, “confirm delivery (client)”, “confirm return (client)”, and “confirm return (offeror)” where all four are linked to a function group “capture” including “image(s)” and “Video(s)”. The “Booking/order detail” 662 function group further include “contact client”, “cancel booking/order”, “review offeror”, “review client”, and “buy (client)”.

As to the presented figures, FIG. 6E shows a fifth subsection of an example of a schematic functional interrelation flowchart diagram. The fifth subsection of the schematic functional interrelation flowchart 680 as linked to FIG. 6C via link (F), shows functions group including “device or an item” 682 including “device or an item” “item information” linking to “photos”, videos“, category” and “suggest category”, “location” and “select address”. The function group “device or an item” 682 further include “options and features” linked to “options and features” and “suggest options and features”, and “attributes”. The function group “device or an item” 682 further include “price” linked to “discount” and “add/edit”, and “customized price” and “add/edit”. The function group “device or an item” 682 further include “delivery option(s)”, “return option(s)”, “availability”, “booking method”, “try before buy”, “add-ons”, “cautions”, “other charges & policy”, “dimensions”, “preferences”, and “Muferral Reward Program”.

The fifth subsection of the schematic functional interrelation flowchart 680 has one connection link identified as (F) for linking to FIG. 6C.

It will be understood that unless explicitly stated or specified, the steps described in a process are not ordered and may not necessarily be performed or occur in the order described or depicted. For example, a step A in a process described prior to a step B in the same process, may actually be performed after step B. In other words, a collection of steps in a process for achieving an end-result may occur in any order unless otherwise stated.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” It is further understood that any phrase of the form “A/B” shall mean any one of “A”, “B”, “A or B”, or “A and B”. This construct includes the phrase “and/or” itself.

The above specification, examples, and data provide a complete description of the manufacture and use of the claimed invention. Since many embodiments of the claimed invention can be made without departing from the spirit and scope of the disclosure, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

What is claimed is:

1- A system for transacting commerce using internet, comprising:
a software application embedded on a readable medium on a smartphone;
the software application providing an internet-based commerce venue for offering and bidding on services, goods including vehicles for rent and sales, property for rent and temporary housing for rent;
wherein a user on the software application selects a designation as a provider by selecting to make an offer;
wherein the user can alternatively select a designation as a client by selecting to identify a need;
wherein the user next selects an option for a service or an option to rent goods or property for the offer or the need; and
wherein the provider next identifies the services, the goods or the property for the offer and associated characteristics including timing, delivery, cost and any associated restrictions.

2- The system of claim 1, wherein if there is no present offer satisfying the identified need the client can list the need under a demand list; and
wherein the demand list is available to all users to entice the providers to provide offers for items in the demand list.

3- The system of claim 1, wherein the user establishes an account with the software application providing identifying and financial information; establishing a wallet enabling making payments and receiving funds for transactions initiated through the software application; transferring funds in and out of the wallet;
wherein the identifying information comprises a user name, a nickname, an address, a government issued identification numbers, and a birth date;
wherein the financial information comprises information on a plurality of financial accounts including a bank account information, a credit card information, other financial institution information; and an authorization for deposit into and withdraw from the financial accounts; and
the software application can provide a plurality of financial transaction reports for accounting and tax purposes.

4- The system of claim 1, wherein information from the software application is available in a plurality of currencies, languages and measurement units according to user preference or a geographical location the information is entered or accessed; and
wherein users are alerted as to different time zones when requesting or offering the services.

5- The system of claim 1, wherein the user is the provider and identifies characteristics of the service transaction as to service type, location, duration, timing and price;
wherein the provider identifies characteristics of the goods for sale or rent or the property for rent transaction as to type of the goods or property, required eligibilities of the client bidding for the goods or property, delivery and collection location, duration and price for rent or sale of the goods or rent of the property;
wherein eligibility comprises consideration of the client's history of transactions and quality rating, dynamic real time user identified criteria, pre-established criteria including client's training or certification in use of the goods, client minimum age requirement, or a combination thereof; and
wherein the provider may identify another user influential in the transaction offer resulting in both the provider and the other user receiving a percentage of transaction fee payable to the software application.

6- The system of claim 1, wherein the user is the client bidding for services, goods to rent or buy or property to rent;
wherein the client can see available offers identified on a map;
wherein the client can limit a search area for available offers on the map by drawing a boundary around an area of interest on the map displayed on the smartphone screen;
wherein upon selecting a suitable offer, client accepts the provider identified characteristics of the goods or property or makes a bidding offer different from provider's proposed price, time and duration availability; and
wherein the client can propose a dynamic real time user identified criteria to be tracked for the services, goods, and property offered by the provider to be used by clients for evaluating the offer.

7- The system of claim 1, wherein the provider provides an option for the client to try the goods as rental before buying the goods.

8- A method for transacting commerce using internet, comprising:
a user using a software application embedded on a readable medium on a smartphone, providing an internet-based commerce venue for offering and bidding on services, goods including vehicles for rent and sales, property for rent and temporary housing for rent;
the user selecting a designation as a provider by selecting to make an offer on the software application;
the user alternatively selecting the designation as a client by selecting to identify a need;
the user next selecting an option for a service or an option to lease goods or property for the offer or the need; and
wherein the provider next identifies the services, the goods or the property for the offer and associated characteristics including timing, delivery, cost and any associated restrictions.

9- The method of claim 8, wherein if there is no present offer satisfying the identified need, the client can list the need under a demand list; and
making the demand list available to all users, enticing the providers to provide offers for items in the demand list.

10- The method of claim 8, wherein the user establishing an account with the software application providing identifying and financial information; establishing a wallet enabling making payments and receiving funds for transactions initiated through the software application; transferring funds in and out of the wallet;
wherein the identifying information comprises a user name, a nickname, an address, a government issued identification numbers, and a birth date;
wherein the financial information comprises information on a plurality of financial accounts including a bank account information, a credit card information, other financial institution information; and authorizing depositing into and withdrawing from the financial accounts; and
enabling the software application to provide a plurality of financial transaction reports for accounting and tax purposes.

11- The method of claim 8, wherein the user accessing or entering information on the software application in a plurality of currencies, languages and measurement units according to user preference or a geographical location the information is entered or accessed; and
the users being alerted as to different time zones when user is requesting or offering the services.

12- The method of claim 8, wherein the provider identifying characteristics of the service transaction offer as to service type, location, duration, timing and price;
wherein the provider identifying characteristics of the offered goods for sale or rent or the property for rent transaction as to type of the goods or property, required eligibilities of the client bidding for the goods or property, delivery and collection location, duration and price for rent or sale of the goods or rent of the property;
wherein eligibility comprises considering the client's history of transactions and quality rating, dynamic real time user identified criteria, pre-established criteria including client's training or certification in use of the goods, client minimum age requirement, or a combination thereof; and
wherein the provider may be identifying another user influential in the transaction offer resulting in both the provider and the other user receiving a percentage of transaction fee payable to the software application.

13- The method of claim 8, wherein the client bidding for services, goods to rent or buy or property to rent can see available offers identified on a map;
wherein the client limiting a search area for available offers on the map by drawing a boundary around an area of interest on the map displayed on the smartphone screen;
wherein upon selecting a suitable offer, the client accepts the provider identified characteristics of the services, goods or property or makes a bidding offer different from provider's proposed price, time and duration availability; and
wherein the client can propose a dynamic real time user identified criteria to be tracked for the services, goods, and property offered by the provider to be used by clients for evaluating the offer.

14- The method of claim 8, wherein the provider providing an option for the client to try the goods as rental before buying the goods.

15- A computer software product embedded on a readable medium on a computer providing a virtual storefront for transacting commerce via internet, comprising:
a software program including a database embedded on the readable medium on a server computer, communicating via internet with a plurality of software applications embedded on a plurality of smartphones;
wherein the software program registers users of the software application as a provider offering services, goods for rent and sale or property for rent, and a client in need of services, goods to rent or buy or property to rent;
wherein the software program maintains an identification information and a bank account and a credit card information of the users in the database;
wherein the software program further maintains a list of offered services, goods for rent or sale, or property for rent associated with the offering provider;
wherein the software program lists the offered services, goods for rent or sale, and property for rent in response to a client in need of services, goods to rent or buy, or property to rent;
wherein the software program further provides characteristics information provided by the provider of services, goods for rent or sale or property for rent as to type of the services, goods or property, required eligibilities of the client bidding for the services, goods or property, delivery and collection location, duration and price for the services or for rent or sale of the goods or rent of the property; and
wherein the software program provides the virtual storefront for the provider and the client to negotiate the transaction involving the services, goods or property.

16- The software program of claim 15, wherein if there is no present offer to satisfy the identified need, the client can list the need under a demand list; and
make the demand list available to all users, enticing the providers to provide offers for items in the demand list.

17- The software program of claim 15, wherein a history of user transactions is maintained in the database to enable the software program to provide a plurality of financial transaction reports for accounting and tax purposes.

18- The software program of claim 15, wherein the characteristics information can be provided in a plurality of currencies, languages and measurement units according to user preference or a geographical location the information is entered or accessed on the software application; and
Wherein the software program alerts users as to different time zones when requesting or offering the services.

19- The software program of claim 15, wherein in response to the client need the software program shows all the corresponding offers on a map; and
Wherein the software program in response to the client limiting a search area for available offers on the map, by the client drawing a boundary around an area of interest on the map displayed on the smartphone screen, limits the search area for available offers.

20- The software program of claim 15, wherein the provider provides an option for the client to try the goods as rental before buying the goods.
